(19) United States
(12) Patent Application Publication
(10) Pub. No.: US 2009/0327086 A1
(43) Pub. Date: Dec. 31, 2009

(54) Non-Optical Mobile Electronic Transaction System, Device and Method Therefor

(76) Inventor: Thomas E. Homeier-Beals, Livonia, MI (US)

Correspondence Address: The Weintraub Group, 32000 Northwestern Hwy Suite 240, Farmington Hills, MI, 48334, US

(21) Appl. No.: 11/991,816

(22) PCT Filed: Jul. 9, 2006
(86) PCT No.: PCT/US2006/034888

§ 371 Date: Mar. 10, 2008

Related U.S. Application Data
(60) Provisional application No. 60/714,985, filed on Sep. 8, 2005.

(51) Int. Cl. G06Q 30/00; H04Q 5/00; G06F 17/00

(52) U.S. Cl. 705/21; 705/23; 340/10.51; 235/375

(57) ABSTRACT

Disclosed herein is a non-optical system, device and method for conducting electronic transactions utilizing a wireless communications device adapted to receive a transaction program and data. The device comprises memory storage for storing a transaction program, a microprocessor and a transponder chip. The microprocessor executes instructions contained within the transaction program to program a code segment on the transponder chip. The transponder chip transmits a signal representative of value upon detection of an activation signal. As disclosed herein, value is selected from the group consisting an identifier of a purchased good, an identifier of a purchased service, a coupon, a discount, a prepaid transaction, an electronic negotiable instrument, a sum from a credit account, and a sum from a debit account. The signal representative of value is readable by a seamier to complete a transaction. The scanner may be adapted to access a provider server for storing and retrieving user information. The scanner may be a peripheral or integrated device used to activate the transponder chip to transmit value(s), receive and translate value(s) in a non-optical method.

### CROSS REFERENCE TO RELATED APPLICATIONS

This application is a completion application of co-pending U.S. Provisional Application No. 60/714,985, filed Sep. 8, 2005, for “Non-Optical Mobile Electronic Transaction System, Device and Method Therefor,” the entire disclosure of which is hereby incorporated by reference.

### FIELD OF THE INVENTION

The present invention relates to a system, device and method for conducting wireless electronic transactions, and more specifically, the present invention relates to electronic transactions utilizing a non-optical wireless communications device.

### PRIOR ART

Electronic transactions conducted over the Internet, also known as electronic commerce or e-commerce, have enabled individuals to purchase products without leaving their homes. Typically, an e-commerce shopper will access a web site, scroll through goods, some of which may not be available, and then “check out”. The check out process involves providing payment information and arranging for shipping. Many e-commerce retailers charge a significant fee above the actual shipping cost for shipping. Additionally, the shopper has to wait for the goods they purchased to be delivered.

Payment is typically arranged by providing a credit card number online. A significant number of e-commerce shopper's have concerns about providing credit card information over the Internet. Although the liability for credit card holders is limited to $50 under the Fair Credit Billing Act if an unauthorized charge is timely reported, the consumer ultimately pays for the fraud via interest rates and other fees.

New payment systems have been developed which respond in part to the security concerns about providing credit card information to third parties by facilitating the payment portion of a transaction. However, these new payment systems do not respond to concerns where an item is ordered and the e-commerce retailer does not deliver the selected item. The payment system will still charge the shopper's account as soon as the item is ordered. Months may pass before the situation is resolved, ultimately resulting in a dispute with the credit card company.

The proliferation of Internet retail services and the concomitant advertising has enabled our society to become ever more paperless. E-commerce web sites employ many advertising methods to that draw Internet users to their web sites. However, coupons are distributed on paper rather than provided electronically.

Beyond the wired Internet, wireless e-commerce has taken the benefits of the Internet and added mobility. Therefore, it is advantageous to combine the benefits of wireless e-commerce with the mobility of wireless devices such as cellular phones and PDAs to provide immediate completion of a transaction.

One such system that combines wireless mobility and retail commerce is described in U.S. Pat. No. 6,577,861. The '861 patent discloses a wireless telephone connected with a bar code scanner as a substitute for a personal shopping terminal. The '861 patent is an advance in wireless e-commerce, however the system does have shortcomings. The '861 patent does not provide for selecting an item while the shopper is not in the store. Furthermore, the '861 system is limited to purchasing items that have an associated barcode. Lastly, the '861 system does not provide a means for making the transaction more paperless, nor is it applicable to services such as air travel, hotel or rental car accommodations.

Optical reading devices, such as barcode scanners, require the scanner to be able to “read” indicia, such as a bar code, on an object. The scanner may not be able to read the indicia in cases where the indicia has been damaged. Additionally, the scanner must be able to illuminate the indicia, which in some cases may not be practical where the indicia is in an inaccessible location relative to the scanner. Furthermore, as the technology is optical, the scanner or the indicia may become contaminated.

Thus, it is desirable to provide a system, device and method for electronic transactions using a non-optical wireless device for paperless redemption of a coupon, a prepaid transaction, an electronic negotiable instrument, a sum from a credit account, and a sum from a debit account.

### SUMMARY OF THE INVENTION

A system for conducting electronic transactions, comprises a wireless communication device having a programmable transponder chip, memory storage, a display screen and a microprocessor, where the device is adapted to receive a transaction program for programming the transponder chip.

A code segment is stored in the transponder chip, the code segment contains instructions executable by the transponder chip to produce a signal representative of value. The signal representative of value is selected from the group consisting of an identifier of a purchased good, an identifier of a purchased service, a coupon, a discount, a prepaid transaction, an electronic negotiable instrument, a sum from a credit account, and a sum from a debit account.

A merchant scanner has a transceiver and an antenna, where the transceiver is operatively coupled to the antenna for transmitting an activation signal to be received by the transponder chip. When the transponder chip receives the activation signal from the transceiver, the transponder chip transmits a signal representative of value. The transceiver receives the signal representative of value from the transponder chip.

The signal produced by the transponder chip may also represent user identification information. The system may include a provider server accessible by the merchant scanner for storing and retrieving user account information. The provider server may provide the code segment to the transponder chip. The wireless communication device may further comprise an antenna for communication with said provider server. The transponder chip may be an RFID chip.

A wireless communication device for conducting electronic transactions, comprises a programmable transponder chip and memory storage adapted to receive a transaction program for programming the transponder chip, a display screen and a microprocessor. A code segment is stored in the transponder chip, where the code segment contains instructions executable by said transponder chip to produce a signal representative of value, where value is selected from the group consisting of an identifier of a purchased good, an identifier of a purchased service, a coupon, a discount, a prepaid transaction, an electronic negotiable instrument, a sum from a credit account, and a sum from a debit account. The signal representative of value is detectable by a merchant scanner.

A method of conducting electronic transactions comprises the steps of providing a wireless communication device having a programmable transponder chip, memory storage, a display screen and a microprocessor, the device being adapted to receive a transaction program for programming the transponder chip. A scanner generates an activation signal. The device transmits a signal representative of value, where value is selected from the group consisting of an identifier of a purchased good, an identifier of a purchased service, a coupon, a discount, a prepaid transaction, an electronic negotiable instrument, a sum from a credit account, and a sum from a debit account. The scanner receives the signal representative of value from the transponder chip.

The program or code segment may be downloaded from a remote server. A further step may include entering a password before the step of transmitting the signal representative of value.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is a schematic illustration of a network for providing software and data to a wireless communications device according to the principles of the present invention; and

FIG. 2 is a block diagram of a system for conducting electronic transactions according to the principles of the present invention.

### DESCRIPTION OF THE PREFERRED EMBODIMENT

A system provider enables a user to engage in electronic transactions by employing a wireless communications device with a programmable transponder chip. Through a transaction program loaded into the memory of a wireless device, the programmable transponder chip is programmed to produce a signal representative of value.

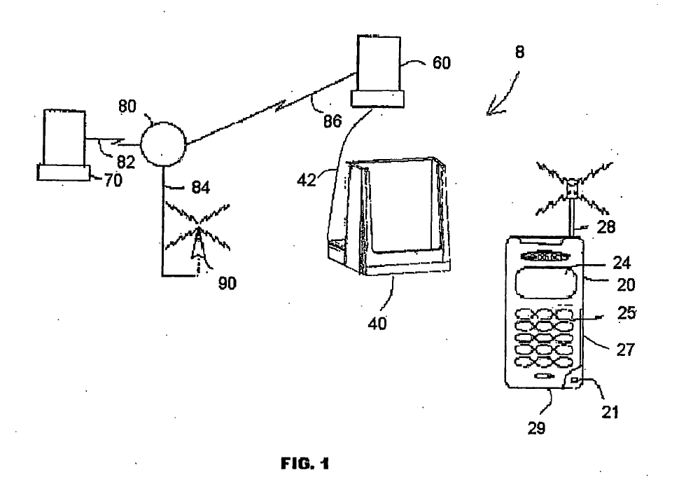

With initial reference to FIG. 1, a schematic illustration of a network 8 for providing software and data to a wireless communications device 20 according to the principles of the present invention is shown. The network 8 comprises a provider server 70 in communication with a network 80, such as the Internet or a wireless network, via a line 82. The network 80 is in communication with a cellular network 90 via a line 84. The provider server 70 is accessible by a terminal 60, such as a personal computer or other terminal, via a line 86, a PBX, or any data transmission system known in the art. A cradle 40 is coupled to the terminal 60 by a cable 42. The provider server 70 has proprietary software that transmits data and software to wireless communications device 20. The proprietary software transmits a transaction program to the wireless device 20, as well as manages and modifies the transaction program.

In the present embodiment, the device 20 is a cellular telephone having an antenna 28, display screen 24, key pad 25, memory card reader 27 and an I/O port 29. Data and software may be downloaded by wireless communications, such as radio signals, laser or infrared, wire communications, such as through the IO port 29, or from external media, such as a memory card through card reader 27. The IO port 29 enables the device 20 to couple to the cradle 40 or any other means known in the art to send and receive data to the terminal 60. The device 20 may send and receive data and software via the cellular network 90 or any wireless network, instead of, or in addition to, data and software sent through IO port 29. It should be noted however, that any communication technology known the art including infrared, laser, or radio, such as Bluetooth®, may be employed to transmit and receive data or software within the network 8.

Although device 20 in the present embodiment is a cellular telephone, it should be apparent to those skilled in the art that any wireless device may be substituted for a cellular telephone including, but not limited to, a PDA (personal digital assistant), a handheld computer, or any device that comprises memory storage, microprocessor and may be adapted to receive a transponder chip.

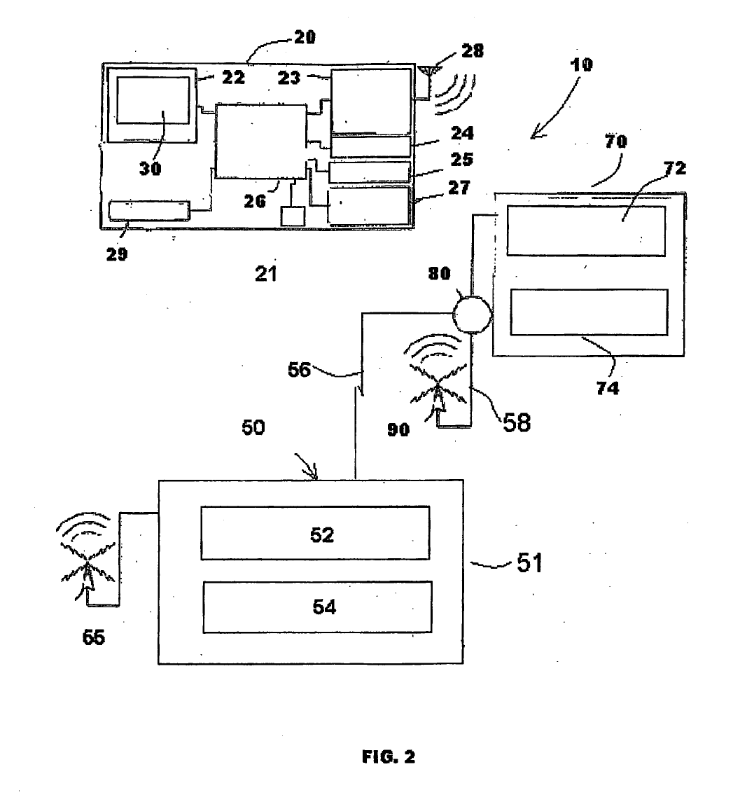

Referring now also to FIG. 2, a block diagram of a system 10 for conducting electronic transactions according to the principles of the present invention is shown. The system 10 includes wireless communication device 20 and a merchant scanner 50. The device 20 has a programmable transponder chip 21, memory storage 22 and a microprocessor 26. The provider server 70 has proprietary software that sends a transaction program 30 to wireless communications device 20. The transaction program 30 is stored in the memory storage 22 of device 20. The program 30 contains instructions executable by the microprocessor 26 to enable the device 20 to program the transponder chip 21. The transaction program 30 programs a code segment in the programmable transponder chip 21. The code segment contains instructions executable by the transponder chip 21 to produce a signal representative of value when the chip 21 receives an activation signal. According to the present invention, value is selected from an identifier of a purchased good, an identifier of a purchased service, a coupon, a discount, a prepaid transaction, an electronic negotiable instrument, a sum from a credit account, and a sum from a debit account.

The wireless communications device 20 has a programmable transponder chip 21. The transponder chip 21 may be programmed a plurality of times. In the preferred embodiment, the transponder chip is an RFID chip, however any suitable technology known in the art may be substituted for RFID.

The merchant scanner 50 comprises a transceiver 51 operatively coupled to an antenna 55. The transceiver 51 has a transmitter 52 for generating an activation signal and a receiver 54 for receiving a signal representative of value from the transponder chip 21. The merchant scanner 50 may communicate information provided by the device 20 with the provider server 70.

In operation, the merchant scanner 50 transmits an activation signal to be received by the transponder chip 21. The code segment on the transponder chip 21 causes the chip 21 to transmit a signal representative of value upon detection of the activation signal. The scanner 50 receives the signal representative of value from said transponder chip 21. The signal representative of value may also contain user identification information.

The provider server 70 comprises a commerce program 72 and database 74. The provider database 74 may include information such as a username, password, bank account information, credit card information, selected coupons, a prepaid transaction, an electronic negotiable instrument, a sum from a credit account and a sum from a debit account. The commerce program 72 provides instructions to enable a user to conduct electronic transactions. Additionally, a user may use the wireless device 20 to browse and select goods, services and coupons. Furthermore, a user may employ the program 30 to locate a participating retailer or service provider.

A user selects a transaction by choosing a good, service, discount or coupon. Once the transaction is selected, the user pays for the good or service by causing the commerce program 72 to debit a credit account, debit a debit account, create an electronic negotiable instrument, create an identifier of a purchased good, or create an identifier of a purchased service. The database 74 records the actions taken by the commerce program 72. The database 74 may also record a prepaid transaction, a selected coupon, a discount, as well as any other pertinent user information, preferences or information indicative of purchasing habits.

In one embodiment, a user will use device 20 to select a transaction including, but not limited to, a good, a service, a ticket, a coupon, a discount, a prepaid transaction, an electronic negotiable instrument, a sum from a credit account, or a sum from a debit account via the transaction program 30 stored on device 20. the program 30 will reprogram the chip 21 with a code segment with instructions to transmit a signal representative of value for the transaction when an activation signal activates the chip 21. Alternatively, the commerce program 72 on the provider server 70 may generate the code segment and transmit the code segment to the device 20.

When a user is ready to complete a transaction at a participating retailer, the device 20 may automatically transmit the signal representative of value for the transaction when an activation signal activates the chip 21 or the user may be prompted for a password. When the device 20 is permitted to transmit the signal representative of value, the merchant scanner 50 will receive the signal and complete the transaction. In one embodiment, the merchant scanner 50 will redeem the transaction by voiding the signal or code segment. In an alternative embodiment, the merchant scanner 50 may be in communication with the merchant server 70 via a network 80, such as the Internet or a wireless network, via a line 56. The network 80 may also be in communication with a cellular network 90 via a line 58. In an alternate embodiment, the transaction program 30 will display an indicia on the display screen 24 of device 20 indicating the transaction has been successful.

In one mode of operation the wireless communication device 20 is in communication with a device adapted to communicate with a network, such as a personal computer connected to the Internet. Any means known in the art for communication between a wireless device and personal computer may be employed, including, but not limited to, a cradle or cable. The data necessary to generate the code segment or the code segment itself may be downloaded from the provider server 70 to the wireless device 20. Furthermore, the browsing and selection of a transaction may be completed through a personal computer and then the necessary data or code segment may be downloaded to the device 20.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

What is claimed is:

1. A non-optical mobile electronic transaction system, comprising:
a wireless communication device, the device including:
(a) a transponder chip;
(b) memory storage means;
(c) a display screen;
(d) a microprocessor; and
(e) means for receiving a transaction program for programming the transponder.

2. The system of claim 1 wherein the transponder chip comprises a code segment containing instructions executable by the chip to produce a signal representative of value.

3. The system of claim 2 which further comprises:
a scanner having a transceiver and an antenna, the transceiver being operatively connected to the antenna for transmitting an activation signal to the transponder, the transportation chip transmitting a signal representative of value to the transceiver responsive to the activation signal.

4. The system of claim 3 which further comprises:
a provider server accessible by the scanner, the server including means for providing the code segment to the transceiver.

5. The system of claim 4 which further comprises:
an antenna, operatively connected to the wireless communication device for receiving signals from the server.

6. The system of claim I wherein the transponder chip is an RFID chip.

7. The system of claim 3 wherein the signal representative of value is selected from the group consisting of an identifier of a purchased good, and identifier of a purchased service, a coupon, a discount, a pre-paid transaction, an electronic negotiable instrument, a sum from a credit account and a sum from a debit account.

8. The system of claim 7 wherein the scanner is a merchant scanner.

9. A method for conducting an electronic transaction comprising:
(a) providing a wireless communicating device, the device including:
(1) a transponder chip having a code segment containing instructions executable by the chip to produce a signal representative of value;
(2) memory storage means;
(3) a display screen;
(4) a microprocessor; and
(5) means for receiving a transaction program;
(b) providing a merchant scanner, the scanner including a transceiver and an antenna connected thereto;
(c) generating an activation signal from the scanner;
(d) receiving the activation signal by the device; and
(e) transmitting a signal representative of value to the device, the signal representative of value being generated by the transponder chip.

10. The method of claim 9 which further comprises:
(a) providing a remote server;
(b) transmitting the code segment from the server to the transponder chip; and
(c) downloading the code segment.

11. The method of claim 9 which further comprises:
entering a password before transmitting the signal representative of value.

12. The method of claim 9 wherein the signal representative of value is selected from the group consisting of an identifier of a purchased good, and identifier of a purchased service, a coupon, a discount, a pre-paid transaction, an electronic negotiable instrument, a sum from a credit account and a sum from a debit account.
